(19) United States
(12) Patent Application Publication
(10) Pub. No.: US 2019/0284786 A1
(43) Pub. Date: Sep. 19, 2019

(54) WASH UNIT FOR A CABIN MONUMENT, CABIN MONUMENT AND UPGRADE KIT FOR A WASHBASIN UNIT

(71) Applicant: AIRBUS DEFENCE AND SPACE GMBH, Taufkirchen (DE)

(72) Inventors: Andreas KÖHLER, Taufkirchen (DE); Fabian REIMER, Taufkirchen (DE); Martin RUECKBRODT, Taufkirchen (DE)

(21) Appl. No.: 16/297,967

(22) Filed: Mar. 11, 2019

(30) Foreign Application Priority Data
Mar. 14, 2018 (DE) 10 2018 203 847.3

(51) Int. Cl. E03C 1/324; B64G 1/60; B64D 11/02; E03C 1/14

(52) U.S. Cl. CPC E03C 1/324; B64G 1/60; E03C 2201/90; E03C 1/14; B64D 11/02

(57) ABSTRACT

A wash unit for a cabin monument of an aircraft/spacecraft, having an adjustable basin which is adjustable between a stowage state of the wash unit, in which the basin is stowed in the cabin monument so as to be inaccessible to a user, and an operational state of the wash unit, in which the basin projects out of a wall of the cabin monument so as to be accessible to a user, a water inflow for conducting water into an internal volume of the basin in the operational state of the wash unit, and a water outflow for conducting water out of the internal volume of the basin in the operational state of the wash unit.

### CROSS-REFERENCE TO RELATED APPLICATION

This application claims priority to German patent application DE 10 2018 203 847.3 filed Mar. 14, 2018, the entire disclosure of which is incorporated by reference herein.

### TECHNICAL FIELD

The disclosure herein relates to a wash unit for a cabin monument of an aircraft/spacecraft, to a cabin monument for an aircraft/spacecraft, and to an upgrade kit for a washbasin unit of an aircraft/spacecraft.

### BACKGROUND

Because of the stringent requirements on aircraft with regard to space and weight saving, there is a need for sophisticated concepts in order to ensure a high level of traveling comfort. Particular attention to the topic of comfort is crucial in the case of long-distance flights, which may readily involve flight durations of over ten hours. Accordingly, there is an interest in finding ways for increasing the comfort of aircraft passengers, but not at the expense of other factors that are possibly considered to be relevant.

Such an aspect is the human requirement for cleanliness and hygiene. Sanitary installations are duly provided in commercial aircraft. Because of the limited space in an aircraft, wash units contained therein are however rather small, and, specifically in the normal traveling class, cover only basic functions. Should a passenger have the desire to wash other parts of the body, such as the arms, the face or even the feet, this is possible at best through the expenditure of great physical effort on the part of the passenger. Also, there is the risk here that water will inevitably reach locations outside the wash unit, which increases the degree of soiling and thus gives rise to increased cleaning requirements.

Against this background, it is an object of the disclosure herein to provide a space-saving apparatus for washing various parts of the body on board an aircraft or spacecraft.

### SUMMARY

According to the disclosure herein, this object is achieved by a wash unit for a cabin monument, a cabin monument, and by an upgrade kit for a washbasin unit having features disclosed herein.

Accordingly, a wash unit for a cabin monument of an aircraft or spacecraft is provided. The wash unit comprises an adjustable basin which is adjustable between a stowage state of the wash unit, in which the basin is stowed in the cabin monument so as to be inaccessible to a user, and an operational state of the wash unit, in which the basin projects out of a wall of the cabin monument so as to be accessible to a user, a water inflow for conducting water into an internal volume of the basin in the operational state of the wash unit, and a water outflow for conducting water out of the internal volume of the basin in the operational state of the wash unit. The wash unit may in particular, and particularly advantageously, be integrated into the wall monument.

A cabin monument for an aircraft/spacecraft having a wash unit according to the disclosure herein is likewise provided.

Also provided is an upgrade kit for a washbasin unit of an aircraft/spacecraft. The upgrade kit comprises a water flow broadening device for attaching to a faucet of the washbasin unit and for broadening the water flow that emerges from the faucet, and a basin enlargement device for inserting into a washbasin of the washbasin unit and for enlarging a water-collecting volume of the washbasin such that all of the water of the broadened water flow can be collected.

The concept on which the disclosure herein is based involves designing a wash unit such that it is possible to switch between a non-operational state and an operational state. In the non-operational state, the wash unit is compact and stowed, and in the operational state, the wash unit is comfortably accessible.

Accordingly, it is possible even in a spatially restricted environment, for example on board an aircraft or spacecraft, to provide a way for comfortably cleaning relatively large areas of the body.

Advantageous embodiments and refinements will emerge from the description with reference to the figures.

According to one refinement of the wash unit, the basin may have a multiplicity of individual elements which delimit or define the internal volume of the basin and which are designed such that the internal volume delimited or defined by the multiplicity of individual elements is smaller in the stowage state of the wash unit than in the operational state of the wash unit. This permits particularly space-saving stowage of the wash unit along with a simultaneously robust design of the individual constituent parts.

According to a further example embodiment of the wash unit, the basin may have a foil which delimits or defines the internal volume of the basin and which is designed such that the internal volume delimited or defined by the foil is smaller in the stowage state of the wash unit than in the operational state of the wash unit. Such foils are of particularly weight-saving and space-saving design and furthermore make it possible for water to be collected without being able to escape through any gaps.

According to a further example embodiment of the wash unit, the basin may have a shell which delimits or defines the internal volume of the basin. This is a particularly simple design and thus reduces the maintenance effort required between flights of the aircraft or spacecraft.

According to one refinement of the wash unit, the water inflow may be coupled to the basin such that the water inflow is stowed in the cabin monument in the stowage state of the wash unit and projects out of the wall of the cabin monument in the operational state of the wash unit. This is particularly advantageous because, in this way, the wash unit is of even more space-saving design.

According to a further embodiment of the wash unit, the wash unit may have at least one rail which is arranged such that the basin is adjustable by the rail from the stowage state into the operational state. This permits a simple and robust design of a wash unit with reduced maintenance effort.

According to a further example embodiment of the wash unit, the wash unit may have at least one telescopic rail which is arranged such that the basin is adjustable by the telescopic rail from the stowage state into the operational state. A telescopic rail permits advantageously space-saving stowage of the wash unit.

According to one refinement of the wash unit, the wash unit may have at least one rotary hinge which is arranged such that the basin is adjustable by the rotary hinge from the stowage state into the operational state.

According to a further example embodiment of the wash unit, the wash unit may have a blower which is arranged such that, in the operational state of the wash unit, an air stream discharged by the blower reaches a user of the wash unit. In this way, the user can advantageously subsequently dry the parts of the body that have been washed.

According to a further embodiment of the wash unit, the wash unit may have a sensor for detecting the presence of a user. It is possible for various functionalities of the wash unit to be controlled by such a sensor. This advantageously makes it possible to use the wash unit without coming into direct contact with the wash unit, which may be desired in particular for hygiene reasons.

According to one refinement of the wash unit, the wash unit may have an adjustment device for adjusting the basin between the stowage state of the wash unit and the operational state of the wash unit in a manner dependent on a signal of the sensor. This is a particularly user-friendly, comfortable design and advantageously yet further reduces the direct contact between user and wash unit.

According to one refinement of the cabin monument, the cabin monument may comprise a first and a second wash unit, wherein the first wash unit is arranged approximately at abdominal height and the second wash unit is arranged approximately at foot height. This makes it possible to wash various parts of the body at one location in the aircraft/spacecraft.

According to a further example embodiment of the cabin monument, the cabin monument may be formed as part of the equipment of an on-board toilet. It is advantageously the case that water supply systems are normally already present in such cabin monuments, to which water supply systems the wash unit can also be connected. Furthermore, this embodiment permits washing with a certain degree of privacy.

According to a further embodiment of the cabin monument, the cabin monument may be formed as a cabin wall for an on-board toilet, and the wall may form an outer wall of the on-board toilet. It is advantageously the case that water supply systems are normally already present in such cabin monuments, to which water supply systems the wash unit can also be connected. Furthermore, the wash unit can advantageously be used without blocking the on-board toilet for other passengers.

According to one refinement of the upgrade kit, the water flow broadening device may have an inlet for connecting to the faucet of the washbasin unit and may have at least one, in particular two spaced-apart outlets, wherein the outlets are connected to the inlet such that water flowing from the faucet into the inlet flows out through the outlets.

In a further embodiment of the upgrade kit, the basin enlargement device may have a water-repellent foil which is arranged such that, after the insertion of the basin enlargement device, the water of the broadened water flow can be collected by the foil.

According to a further example embodiment of the upgrade kit, the basin enlargement device may have a folding device for the folding-together of the basin enlargement device.

The above embodiments and refinements may be combined with one another as desired where expedient. Further possible embodiments, refinements and implementations of the disclosure herein also encompass combinations, which are not explicitly mentioned, of features of the disclosure herein described above or below with regard to the example embodiments. In particular, a person skilled in the art will also add individual aspects as improvements or additions to the respective basic form of the disclosure herein.

### BRIEF DESCRIPTION OF THE DRAWINGS

The disclosure herein will be discussed in more detail below on the basis of the example embodiments shown in the schematic figures. In the figures:

FIG. 1 shows an example embodiment of a wash unit in an operational state;

FIG. 2 shows a further example embodiment of a wash unit in an operational state;

FIGS. 3a and 3b show a further example embodiment of a wash unit in a stowage state and in an operational state;

FIGS. 4a and 4b show a further example embodiment of a wash unit in a stowage state and in an operational state;

FIGS. 5a through 5c show a further example embodiment of a wash unit during a changeover between a stowage state and an operational state;

FIG. 6 shows an example embodiment of a cabin monument;

FIG. 7 shows a further example embodiment of a cabin monument;

FIG. 8 shows an example embodiment of an upgrade kit;

FIG. 9 shows an example embodiment of a water flow broadening device of an upgrade kit;

FIG. 10 shows an example embodiment of a basin enlargement device of an upgrade kit; and

FIG. 11 shows elements of an example embodiment of a basin enlargement device of an upgrade kit.

### DETAILED DESCRIPTION

The appended figures are intended to provide improved understanding of the embodiments of the disclosure herein. The illustrate embodiments and serve, in conjunction with the description, for the explanation of principles and concepts of the disclosure herein. Other embodiments, and many of the stated advantages, will emerge with regard to the drawings. The elements of the drawings are not necessarily shown true to scale relative to one another.

In the figures of the drawings, elements, features and components which are identical, functionally identical and of identical action are denoted in each case by the same reference designations unless stated otherwise.

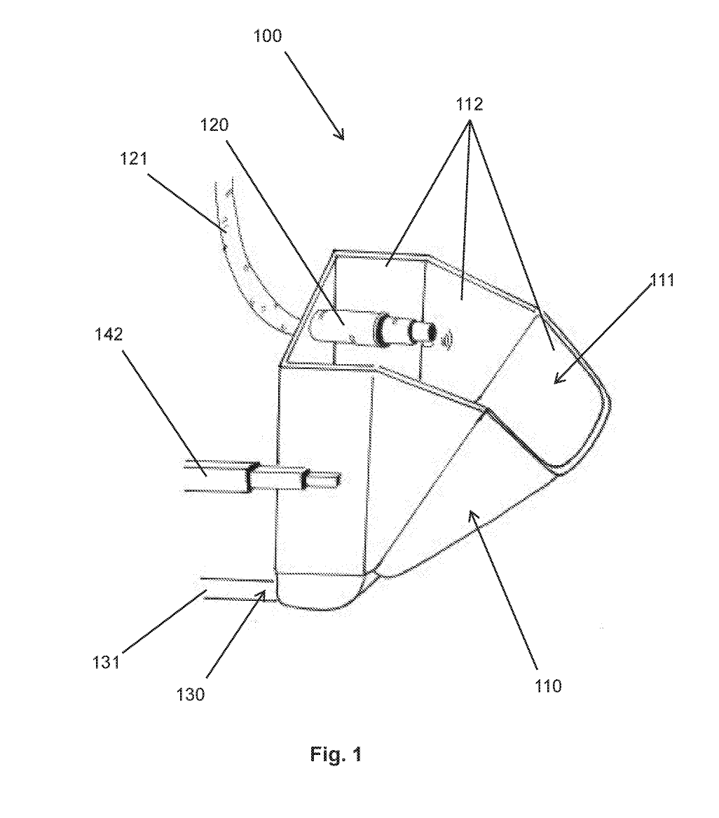

FIG. 1 shows a perspective oblique view of a wash unit 100 for a cabin monument 200 of an aircraft/spacecraft. For the sake of clarity, the cabin monument 200 is not shown in FIG. 1. The wash unit 100 comprises an adjustable basin 110, which is illustrated in FIG. 1 in an operational state. The basin 110 has an internal volume 111, which is delimited or defined by a multiplicity of individual elements 112 of the basin 110. FIG. 1 furthermore shows a water inflow 120, which is supplied with water via a flexible hose 121, and a telescopic rail 142 of the wash unit 100. A water outflow 130, which is not visible in this perspective, is arranged in the lower region of the basin 110 and is connected to a hose 131.

In this example embodiment, the basin 110 comprises four individual elements 112, a rear wall, a front wall and two side walls. Here, a rear wall refers to that individual element 112 which, in the operational state of the wash unit 100, is closest to the wall 210 of the cabin monument 200. The rear wall has, as viewed from above, a forwardly curved U shape. The front wall is formed by that individual element 112 which, in the operational state of the wash unit 100, is furthest remote from the wall 210 of the cabin monument 200. The front wall has, as viewed from above, a rearwardly curved U shape. The remaining two individual elements 112 connect the rear wall and the front wall and thus form side walls. Here, the side walls lie against the inner side of the rear wall. The front wall in turn lies against the inner sides of the side walls.

In a stowage state (not shown), the forwardly and rearwardly curved portions of the rear wall and front wall respectively and the side walls are arranged congruently. The individual elements 112 thus delimit or define a rather small internal volume 111. To move into an operational state, the side walls and the front wall are tilted forward and locked. The upper edges and the bases of the individual elements 112 now describe a downwardly directed arc. The internal volume 111, delimited or defined by the individual elements 112, of the basin 110 is enlarged in relation to the stowage state.

The rear wall is additionally fastened laterally to two telescopic rails 142, only one of which is shown in FIG. 1. The telescopic rails 142 are in turn fastened to the cabin monument 200 (not shown). For the stowage state, the telescopic rails 142 are brought into a retracted state, in which the adjustable basin 110 can then be stowed in a recess of the cabin monument 200. By exerting a pulling force on the basin 110, not only are the individual elements 112 tilted forward, but also the telescopic rails 142 are moved into an extended state, in which the basin 110 projects out of a wall 210 of the cabin monument 200.

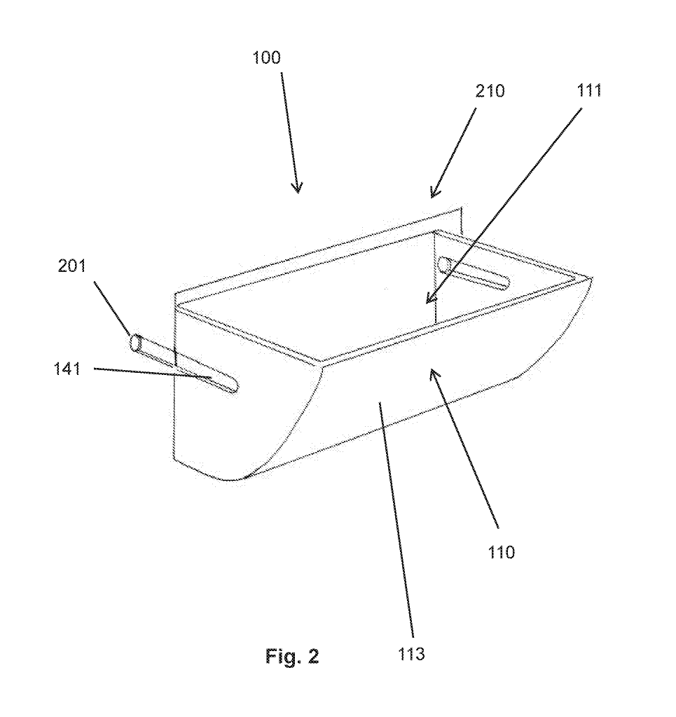

FIG. 2 shows a further example embodiment of a wash unit 100 in an operational state. A water inflow 120 and a water outflow 130 are not shown in FIG. 2. A basin 110 of the wash unit 100 comprises a shell 113 which delimits or defines an internal volume 111 of the basin. The shell 113 laterally comprises two elongated recesses which, in this example embodiment, serve functionally as rails 141. The cabin monument 200 comprises, within a recess, two stop elements 201 which engage into the rails 141 of the shell 113.

In a stowage state (not shown) of the wash unit from FIG. 2, the basin 110 has been displaced along the rails 141 into the recess of the cabin monument 200 and stowed therein. By exerting a pulling force on the basin 110, the latter is pulled out of the recess of the cabin monument 200 until the stop elements 201 abut against the ends of the rails 141. The basin 110 now, in the operational state of the wash unit 100 shown in FIG. 2, projects out of the wall 210 of the cabin monument.

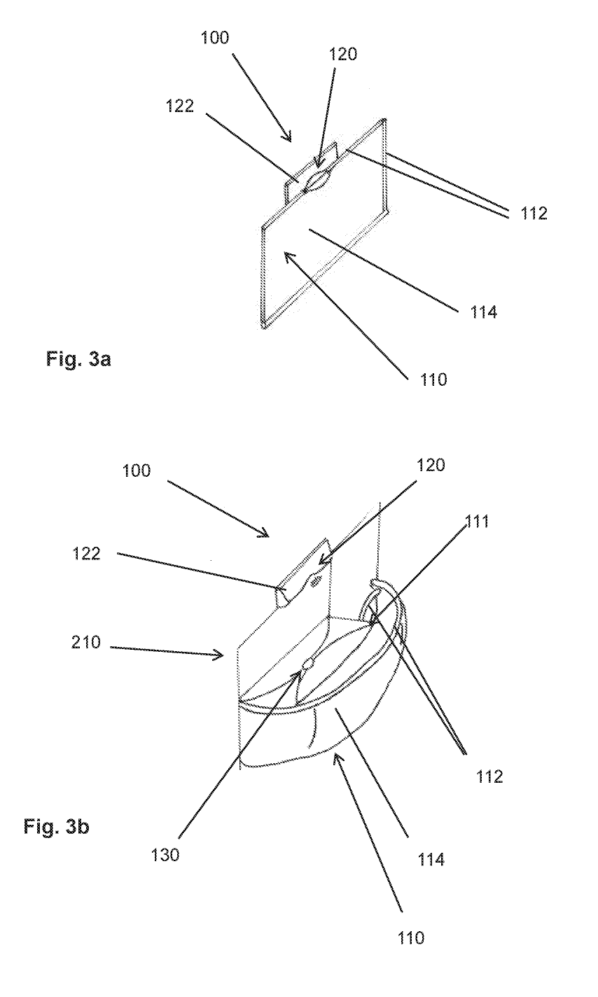

FIGS. 3a and 3b show a schematic view of a further wash unit 100. The wash unit shown here comprises an adjustable basin 110 which comprises a foil 114 and three further individual elements 112. The water inflow 120 is, in the example embodiment shown here, integrated in a downwardly opened flap 122.

FIG. 3a shows a stowage state of the wash unit 100 shown here. In the stowage state, both the basin 110 and the flap 122 bear flush against a wall 210 of a cabin monument 200. The three individual elements 112 are formed as flexible rods which form a frame and which are arranged at the lateral edges and the upper edge of a recess in the wall 210 of the cabin monument 200. The foil 114 is fastened both to the individual elements 112 and to the lower edge of the recess.

FIG. 3b shows an operational state of this example wash unit 100. For this purpose, the individual elements 112 have been bent forward. As a result, the foil 114 fastened to the individual elements 112 assumes a downwardly domed form. This domed form of the foil 114 forms, in conjunction with the recess of the wall 210, an internal volume 111 of the basin 110. In the center of the downwardly domed base of the recess of the wall 210, it is now possible to see a water outflow 130, through which water can flow out of the internal volume 111 of the basin 110. The flap 122 is additionally pivoted forward and locked. Water can now flow out of the water inflow 120 into the internal volume 11 of the basin 110.

In a manner which is not expressly shown, it is possible in this example embodiment for a sensor to be provided within the flap 122, which sensor makes it possible to open or close the water inflow 120 in a manner dependent on the presence of a user. It is likewise optionally possible for a blower to be provided in the flap 122, which blower can, by a warm air stream, dry the parts of a body of a user that are to be washed. Such a blower may likewise be controlled by an optional sensor.

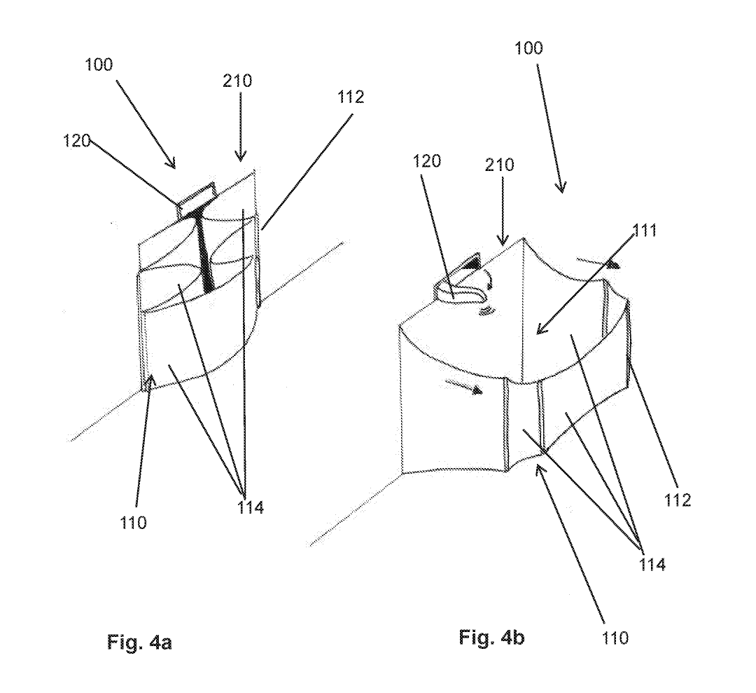

FIGS. 4a and 4b show a further example embodiment of a wash unit 100. The wash unit comprises a basin, which comprises a multiplicity of individual elements 112 and a multiplicity of foils 114. A water inflow 120 is arranged above the basin. A water outflow 130 is not illustrated in FIGS. 4a and 4b. Vertically oriented foils 114 are connected to one another by vertically oriented, rod-shaped individual elements 112.

FIG. 4a shows a stowage state of the example wash unit 100. Here, vertically oriented foils 114 lie folded against a wall 210 of a cabin monument 200. The vertically oriented, rod-shaped individual elements 112 also lie against the wall 210 of the cabin monument 200. In this state, the internal volume 111, delimited or defined by the foils 114 and individual elements 112, of the basin 110 is substantially zero, and the basin 110 is thus inaccessible to a user. In the stowage state, the water inflow 120 is also arranged flush with the wall 210 of the cabin monument 200, and is inaccessible.

By exerting a pulling force on the basin 110, the wash unit 100 is moved into the operational state shown in FIG. 4b. The vertically oriented foils 114 are unfolded. The rod-shaped individual elements 112 form a frame which tensions the foils 114. The foils 114 and individual elements 112 now delimit or define an internal volume 111 of the basin, which projects out of the wall 210 of the cabin monument 200. The water inflow 120 can, by a rotary hinge (not shown), be rotated about a vertical axis such that the water inflow 120 likewise projects out of the wall 210. Water can now flow from the water inflow 120 into the internal volume 111 of the basin 110.

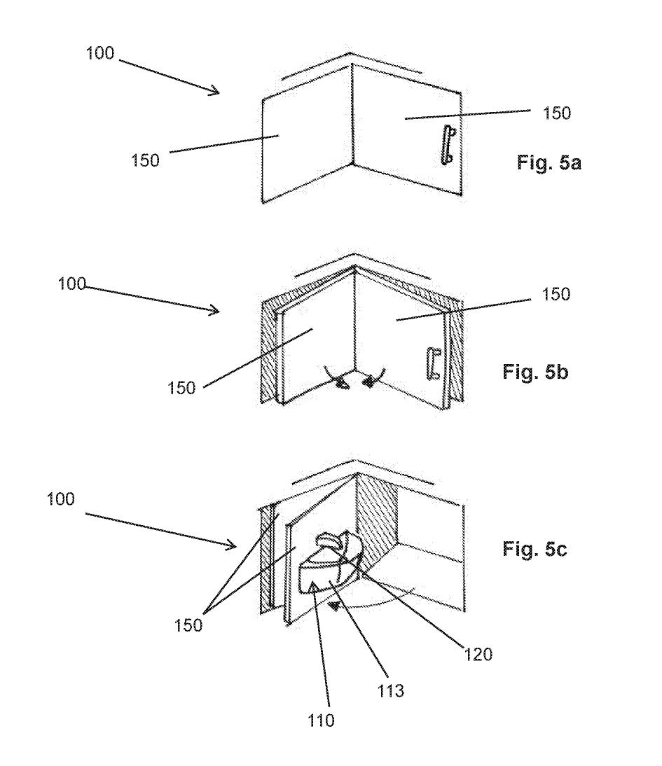

FIGS. 5a to 5c show a further example embodiment of a wash unit 100. The wash unit 100 comprises a basin 110, which comprises a shell 113. The wash unit furthermore comprises a water inflow 120 in the form of a faucet, two plates 150, and a water outflow 130 (not shown).

FIG. 5a shows the example wash unit 100 in a stowage state. From this perspective, only the two plates 150 of the wash unit 100 are visible, which are at right angles to one another and form an internal corner of a cabin monument 200. The basin 110 and water inflow 120 are arranged on a non-visible side of one of the two plates 150 and are stowed in a recess, concealed by the plate 150, of the cabin monument 200.

FIG. 5b shows a first step for the changeover of the wash unit from the stowage state to the operational state. The plates 150 are tilted vertically relative to one another and are thus decoupled from the walls 210 of the cabin monument 200 and coupled to a rotary mechanism (not shown). The plates 150 can now be rotated jointly about a vertical axis.

Finally, FIG. 5c shows a second step between the stowage state and the operational state of the example wash unit 100. As a result of rotation of the plates 150, the basin 110 and the water inflow 120 become visible. In an operational state of the wash unit 100, the plate 150 on which the basin 110 and the water inflow 120 are arranged lies against that wall 210 of the cabin monument 200 which, in the stowage state, is situated opposite the plate 150. The basin 110 and water inflow 120 project, so to speak, out of the wall 210 and are accessible to a user.

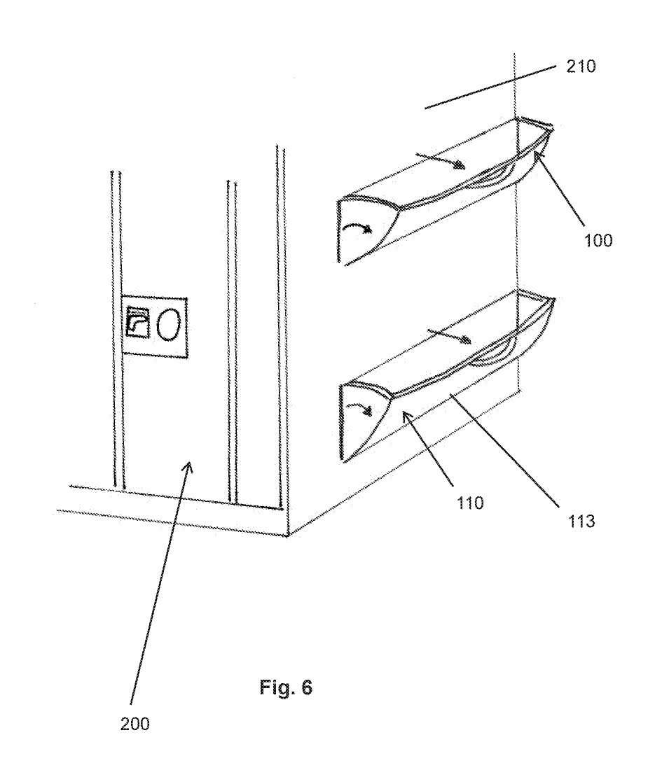

FIG. 6 shows an example embodiment of a cabin monument 200. The cabin monument 200 shown here serves as a delimitation of a room used as an on-board toilet. Two wash units 100 are arranged on the outer side of the cabin monument 200.

In this example embodiment, the wash units 100 are of identical design and comprise in each case one basin 110. Any water inflows 120 and water outflows 130 are not shown in FIG. 6. In the example embodiment shown in FIG. 6, the basins 110 comprise shells 113 which, in a stowage state, are stowed in the cabin monument 200 and which can be tilted forward by rotation in order to project out of a wall 210 of the cabin monument 200 in an operational state. In this example embodiment, one wash unit 100 is arranged approximately at abdominal height, and the other wash unit 100 is arranged approximately at foot height. A user can thus wash hands, arms and/or feet without blocking the on-board toilet for other passengers.

It is advantageous here for the water inflows 120 and water outflows 130 to be connected to water lines which are situated in the cabin monument 200 and which also supply water to the on-board toilet. In FIG. 6, the wash units 100 are shown as having handles. These handles serve for the exertion of a pulling force on the wash units by the user in order to move the wash units from the stowage state into the operational state. Alternatively, an adjustment device may also be provided which is coupled to a sensor and which automatically adjusts the wash units between the operational state and the stowage state in a manner dependent on a user-detecting signal of the sensor.

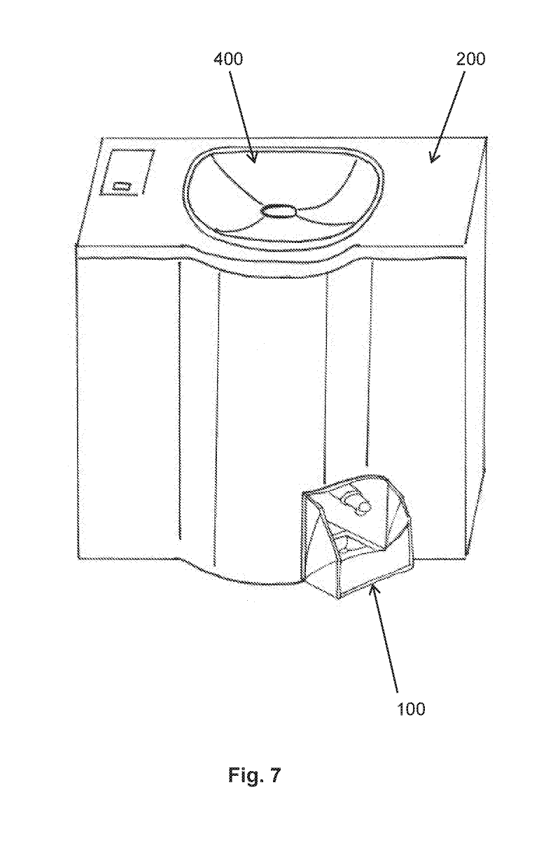

FIG. 7 shows a further example embodiment of a cabin monument 200. The cabin monument 200 shown here is designed as an item of equipment of an on-board toilet. The cabin monument has a substantially cuboidal body which, on its front side facing toward a user, has a bulge. A washbasin unit 400 is arranged on the top side of the body. At one side of the bulge of the body, at floor height, there is arranged a further wash unit 100. This wash unit 100 corresponds substantially to the wash unit shown in FIG. 1 and is illustrated in an operational state.

It is advantageous for both the washbasin unit 400 and the wash unit 100 to be served by the same water supply system. By this cabin monument 200, a passenger of the aircraft/spacecraft can clean both their hands/arms and their feet in the privacy of the on-board toilet. Provision may also be made for an upgrade kit 300, described below, to be provided for the washbasin unit 400.

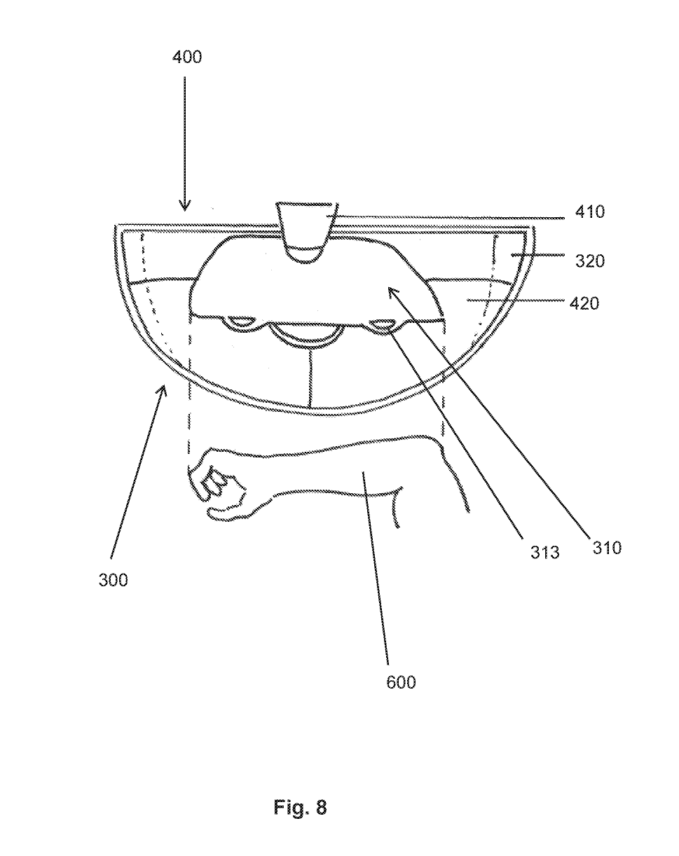

FIG. 8 shows a washbasin unit 400 equipped with an upgrade kit 300 in a view from above. The washbasin unit 400 comprises a faucet 410 and a washbasin 420, the substantially semi-circular edge of which is indicated by a dashed line. The upgrade kit 300 comprises a water flow broadening device 310, which from this perspective is substantially semi-circular and which, at its straight edge, has two outlets 312, and a basin enlargement device 320, which encloses a substantially semi-circular region.

The water flow broadening device 310 is fastened at its arcuate side to the faucet 410 of the washbasin unit 400. The basin enlargement device 320 is inserted into the washbasin 420 of the washbasin unit 400. The radial extent of the basin enlargement device 320 is larger than the dimensions of the washbasin 420. The basin enlargement device 320 thus expands the region in which water can be collected. A forearm 500 of a user is shown. The straight edge of the water flow broadening device 310 extends over the entire forearm 500, including the hand. The entire forearm 500 including the hand likewise has space in the space enclosed by the basin enlargement device 320. Water emerging from the two outlets 312 of the water flow broadening device 310 covers the forearm 500 and is collected by the basin enlargement device 320.

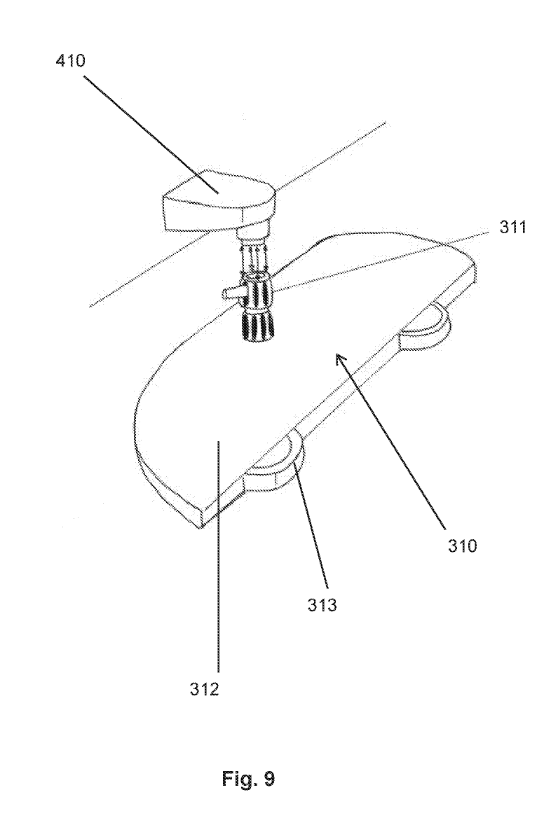

FIG. 9 shows an example embodiment of a water flow broadening device 310. The water flow broadening device 310 has a hollow body 313, an inlet 311, and two spaced-apart outlets 312. The hollow body is of plate-shaped form and has a semi-circular outline. The inlet 311 is arranged on the top side in the vicinity of the arcuate edge of the hollow body 313. The outlets 312 are arranged at opposite ends of the straight edge of the hollow body 313.

The inlet 311 can be attached to a faucet 410 of a washbasin unit 400. Water flowing out of the faucet 410 is then conducted through the inlet 311 into the hollow body 313 and through the latter to the two outlets 312. The water then emerges from the outlets 312 in a broadened manner and flows into the washbasin 420 of the washbasin unit 400.

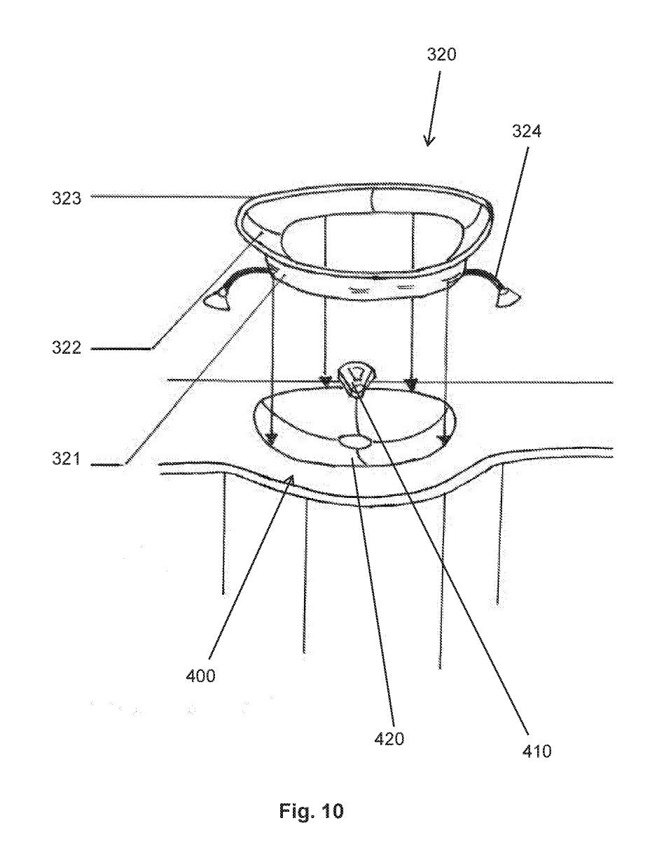

FIG. 10 shows an example embodiment of a basin enlargement device 320 and of a washbasin unit 400. The basin enlargement device has a rigid cylinder element 321, a domed bowl element 322, and a ring-shaped edge element 323. The washbasin unit 400 has a faucet 410 and a washbasin 420. In FIG. 10, the basin enlargement device 320 has, by way of example, two optional fixing devices 324 which, in this case, are in the form of suction cups fastened by cords to the cylinder element.

The cylinder element 321 can be inserted into the washbasin 420. Here, the radius of the cylinder element 321 is preferably at most as large as the outer radius of the washbasin 420. The edge element 323 holds the bowl element 322 in shape. The domed bowl element 322 thus enlarges the region of the washbasin unit 400 in which water from the faucet 410 can be collected.

The basin enlargement device 320 is shown in FIG. 10 in a state prior to insertion into the washbasin 420. Downwardly directed arrows indicate that the basin enlargement unit 320 is to be inserted into the washbasin 420. It should however be noted here that, in reality, the basin enlargement device 320 must be inserted into the washbasin 420 on a slightly oblique path in order to be positioned under the faucet 410.

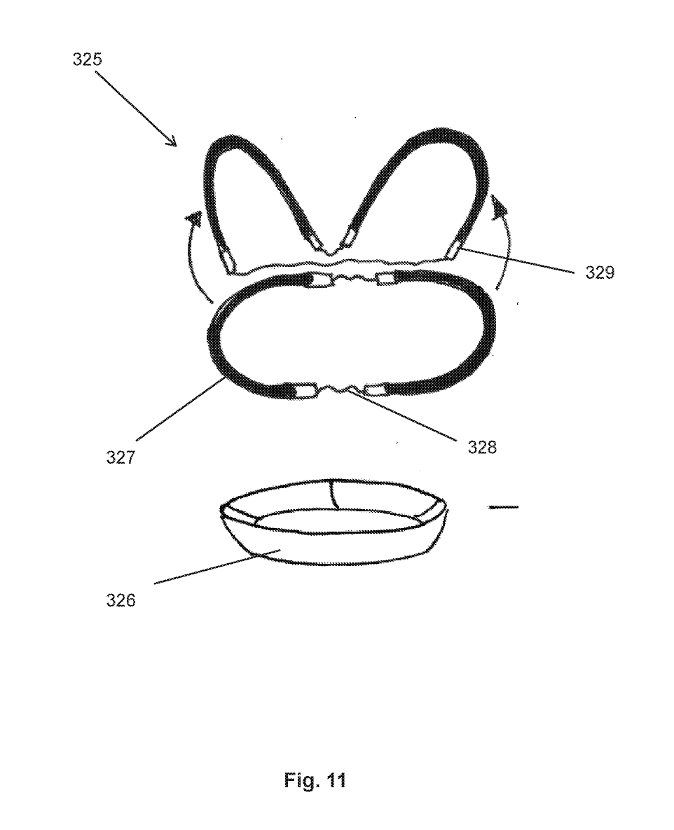

The basin enlargement device 320 shown in FIG. 10 constitutes a rather rigid example embodiment of a basin enlargement device 320. For use in aircraft/spacecraft, it may however be advantageous for a basin enlargement device 320 to be designed to be foldable. For this purpose, a basin enlargement device 320 may for example comprise the elements illustrated in FIG. 11.

FIG. 11 shows a folding device 325 and a collecting foil 326, which may form constituent parts of a basin enlargement device 320.

The folding device 325 comprises two hollow rods 327, which have been bent to form half-rings, and an elastic ring cord 328. The ring cord 328 runs in this case through the inner tubes of the hollow rods 327. In the folded-together state, the two hollow rods 327 can be placed congruently one over the other. In the unfolded state, the hollow rods 327 are plugged into one another by coupling devices 329 arranged on their ends, and form a stable ring because of the elastic tensile force of the ring cord 328.

The collecting foil 326 has substantially a collar shape. Here, “collar shape” means the shape of a shell surface of a frustum. Here, the collecting foil 326 forms a continuous ring, wherein one edge length is longer than the other edge length. Along the edges, the foil may have hoses (not illustrated here). The foil may be manufactured from elastic material, and folding devices 325 may be arranged within the hoses. It is thus possible for the foil to be folded together in a space-saving manner and unfolded for use as part of a basin enlargement device 320.

The disclosure herein has been described in detail above on the basis of a number of preferred example embodiments. It is however not the intention for the disclosure herein to be restricted to the example embodiments illustrated here. Accordingly, a multiplicity of further example embodiments which realize the concept of the disclosure herein is also conceivable.

For example, the individual elements 112 of a basin 110 of a wash unit 100 have been described here as being substantially rectangular or rod-shaped. Other shape configurations are however also conceivable, such as disks, rings, blocks, tubes etc.

The materials of which individual constituent parts of the wash units 100 and upgrade kits 300 described here are composed have also intentionally been left unmentioned. A multiplicity of possible manufacturing materials, such as for example plastics, fiber composite materials, rubber, metals, etc., are evident to a person skilled in the art. A person skilled in the art may freely decide which out of these materials appear expedient to him or her for a specific embodiment of the disclosure herein. In general, it will be advantageous if components that come into contact with water are of water-resistant and/or water-impermeable form. A person skilled in the art will identify which components of a specific embodiment of the disclosure herein this applies to.

It is also pointed out that the use of the expression “foil” in the context of the disclosure herein is not intended to be understood as a restriction with regard to the material thickness of a constituent part referred to as “foil”. Rather, it is meant generally that such a component is intended to have a smaller extent in one spatial direction than in the other spatial directions, and that the component is intended to be composed of or comprise a flexible and/or elastic material.

Most of the example embodiments presented here have been described as being such that a user manually imparts the pulling force required in order to change a state of a described wash unit. It is however also conceivable for every embodiment that the corresponding forces are automatically imparted by an electromechanical system on the basis of sensor signals or other user inputs, such as for example the pushing of a button.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE DESIGNATIONS

100 Wash unit

110 Basin

111 Internal volume

112 Individual element

113 Shell

114 Foil

120 Water inflow

130 Water outflow

141 Rail

142 Telescopic rail

150 Plate

200 Cabin monument

201 Stop element

210 Wall

300 Upgrade kit

310 Water flow broadening device

311 Inlet

312 Outlet

313 Hollow body

320 Basin enlargement device

321 Cylinder element

322 Bowl element

323 Edge element

324 Fixing device

325 Folding device

326 Collecting foil

327 Hollow rod

328 Ring cord

329 Coupling device

400 Washbasin unit

410 Faucet

420 Washbasin

500 Forearm

1. A wash unit for a cabin monument of an aircraft or spacecraft, the wash unit comprising:
an adjustable basin which is adjustable between a stowage state of the wash unit, in which the basin is stowed in the cabin monument and inaccessible to a user, and an operational state of the wash unit, in which the basin projects out of a wall of the cabin monument and is accessible to a user;
a water inflow for conducting water into an internal volume of the basin in the operational state of the wash unit; and
a water outflow for conducting water out of the internal volume of the basin in the operational state of the wash unit.

2. The wash unit of claim 1, wherein the basin has a multiplicity of individual elements which define the internal volume of the basin and which are configured such that the internal volume defined by the multiplicity of individual elements is smaller in the stowage state of the wash unit than in the operational state of the wash unit.

3. The wash unit of claim 1, wherein the basin has a foil which defines the internal volume of the basin and which is configured such that the internal volume defined by the foil is smaller in the stowage state of the wash unit than in the operational state of the wash unit.

4. The wash unit of claim 1, wherein the basin has a shell which defines the internal volume of the basin.

5. The wash unit of claim 1, wherein the water inflow is coupled to the basin such that the water inflow is stowed in the cabin monument in the stowage state of the wash unit and projects out of the wall of the cabin monument in the operational state of the wash unit.

6. The wash unit of claim 1, wherein the wash unit has at least one rail which is arranged such that the basin is adjustable by the rail from the stowage state into the operational state.

7. The wash unit of claim 1, wherein the wash unit has at least one telescopic rail which is arranged such that the basin is adjustable by the telescopic rail from the stowage state into the operational state.

8. The wash unit of claim 1, wherein the wash unit has at least one rotary hinge which is arranged such that the basin is adjustable by the rotary hinge from the stowage state into the operational state.

9. The wash unit of claim 1, wherein the wash unit has a blower which is arranged such that, in the operational state of the wash unit, an air stream discharged by the blower reaches a user of the wash unit.

10. The wash unit of claim 1, wherein the wash unit has a sensor for detecting the presence of a user.

11. The wash unit of claim 10, wherein the wash unit has an adjustment device for adjusting the basin between the stowage state of the wash unit and the operational state of the wash unit in a manner dependent on a signal of the sensor.

12. A cabin monument for an aircraft or spacecraft, wherein the cabin monument comprises a wash unit of claim 1.

13. The cabin monument of claim 12, wherein the cabin monument comprises a first and a second wash unit, wherein the first wash unit is arranged approximately at abdominal height and the second wash unit is arranged approximately at foot height.

14. The cabin monument of claim 12, wherein the cabin monument is formed as part of equipment of an on-board toilet.

15. The cabin monument of claim 12, wherein the cabin monument is formed as a cabin wall for an on-board toilet, and the wall forms an outer wall of the on-board toilet.

16. An upgrade kit for a washbasin unit of an aircraft or spacecraft, comprising:
a water flow broadening device for attaching to a faucet of the washbasin unit and for broadening the water flow that emerges from the faucet; and
a basin enlargement device for inserting into a washbasin of the washbasin unit and for enlarging a water-collecting volume of the washbasin such that all of the water of the broadened water flow can be collected.

17. The upgrade kit of claim 16, wherein the water flow broadening device has an inlet for connecting to the faucet of the washbasin unit and has at least one or more spaced-apart outlet, wherein the at least one or more outlet is connected to the inlet such that water flowing from the faucet into the inlet flows out through the at least one or more outlet.

18. The upgrade kit of claim 16, wherein the basin enlargement device has a fixing device for the spatial fixing of the basin enlargement device.

19. The upgrade kit of claim 16, wherein the basin enlargement device has a folding device for folding-together of the basin enlargement device.

20. The upgrade kit of claim 16, wherein the basin enlargement device has a collecting foil which is arranged such that, after insertion of the basin enlargement device, the water of the broadened water flow can be collected by the collecting foil.
